(19) United States
(12) Patent Application Publication
(10) Pub. No.: US 2008/0163897 A1
(43) Pub. Date: Jul. 10, 2008

(54) TWO STEP PROCESS FOR POST ASH CLEANING FOR CU/LOW-K DUAL DAMASCENE STRUCTURE WITH METAL HARD MASK

(75) Inventors: JIANSHE TANG, San Jose, CA (US); Willey Weng, Hsin-chu city (TW); Wei Lu, Fremont, CA (US); Han-Wen Chen, San Mateo, CA (US); Tseng-Chung Lee, San Jose, CA (US); Ching Hwa Weng, Hsin- chu city (TW)

Correspondence Address: APPLIED MATERIALS/BLAKELY, 1279 OAKMEAD PARKWAY, SUNNYVALE, CA, 94085-4040, US

(73) Assignee: APPLIED MATERIALS, INC.

(21) Appl. No.: 11/621,867

(22) Filed: Jan. 10, 2007

(51) Int. Cl. B08B 3/04

(52) U.S. Cl. 134/26; 134/95.3

(57) ABSTRACT

A method and apparatus for removing residue on a wafer is described. A first solution is applied to remove a first type of residue from a metal mask on the wafer. A second solution is applied to remove a second type of residue from the metal mask on the wafer.

### TECHNICAL FIELD

This invention relates to the field of wafer cleaning and, in particular, to post ash cleaning for dual damascene structure.

### BACKGROUND

For fabrication of semiconductor devices, thin slices or wafers of semiconductor material require polishing by a process that applies an abrasive slurry to the wafer's surfaces. After polishing, slurry residue is generally cleaned or scrubbed from the wafer surfaces via mechanical scrubbing devices. A similar polishing step is performed to planarize dielectric or metal films during subsequent device processing on the semiconductor wafer.

After polishing, be it during wafer or device processing, slurry residue conventionally is cleaned from wafer surfaces by submersing the wafer into a tank of sonically energized cleaning fluid, by spraying with sonically energized cleaning or rinsing fluid, by mechanically cleaning the wafer in a scrubbing device which employs brushes, such as polyvinyl acetate (PVA) brushes, or by a combination of the foregoing.

Although these conventional cleaning devices remove a substantial portion of the slurry residue which adheres to the wafer surfaces, slurry particles nonetheless remain and may produce defects during subsequent processing. Specifically, subsequent processing has been found to redistribute slurry residue from the wafer's edges to the front of the wafer, causing defects.

Other processes involve multiple steps combining wet processes and dry processes. Such conventional cleaning method requires a rapid transition after a wet cleaning because TiF deposits may rapidly build-up on the wafer.

### BRIEF DESCRIPTION OF THE DRAWINGS

The present invention is illustrated by way of example, and not by way of limitation, in the figures of the accompanying drawings.

FIG. 1 is a flow diagram of a method for cleaning a dual damascene structure with metal hard mask of a wafer.

FIG. 2 is a schematic diagram illustrating one embodiment of residue removal by hard mask etching with a first solution.

FIG. 3 is a schematic diagram illustrating one embodiment of residue removal with a second solution.

FIG. 4 is a schematic diagram illustrating one embodiment of an apparatus for cleaning a dual damascene structure with metal hard mask of a wafer.

FIG. 5 is a photographic illustration showing residues on a wafer.

FIG. 6 is a photographic illustration showing a close up of residues on a wafer.

FIG. 7 is a photographic illustration showing a wafer structure free of residue after the cleaning method described herein.

### DETAILED DESCRIPTION

The following description sets forth numerous specific details such as examples of specific systems, components, methods, and so forth, in order to provide a good understanding of several embodiments of the present invention. It will be apparent to one skilled in the art, however, that at least some embodiments of the present invention may be practiced without these specific details. In other instances, well-known components or methods are not described in detail or are presented in simple block diagram format in order to avoid unnecessarily obscuring the present invention. Thus, the specific details set forth are merely exemplary. Particular implementations may vary from these exemplary details and still be contemplated to be within the spirit and scope of the present invention.

A method and apparatus for cleaning a dual damascene structure with metal hard mask of a wafer in a two-step process is described. A first solution is first applied to the wafer to slightly undercut the metal hard mask. A second solution is applied to dissolve and remove metal fluorite compounds precipitated with time on the wafer.

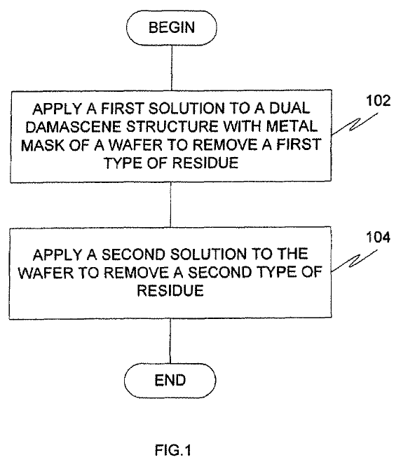

FIG. 1 is a flow diagram 100 of a method for cleaning a dual damascene structure with metal hard mask of a wafer. At 102, a first solution is applied to the wafer remove a first type of residue from a metal mask on the wafer. In accordance with one embodiment, the first solution includes H2O2. The wafer may include a Cu/low-k dual damascene structure with metal hard mask. The metal hard mask may include for example, TiN. The first type of residue may include a residue strongly bonded to the metal mask of the wafer. The first type of residue may include for example, TiF.

At 104, a second solution is applied to the wafer to remove a second type of residue from the metal mask on the wafer. In accordance with one embodiment, the second solution may include a mixture of H2SO4 and HF. The second type of residue may include metal fluorite compounds precipitated with time. The second type of residue may include for example, TiF.

In accordance with another embodiment, the wafer may be rinsed with de-ionized water after applying the first solution and before applying the second solution.

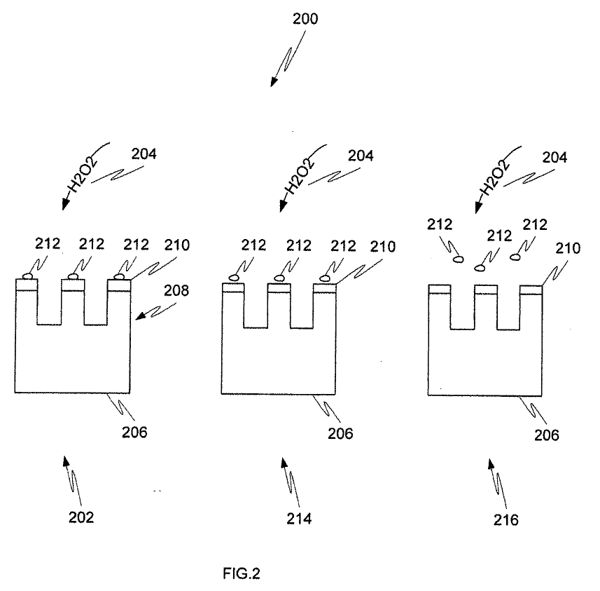

FIG. 2 is a schematic diagram 200 illustrating one embodiment of residue removal by hard mask etching with a first solution 204. At 202, the first solution 204, such as H2O2, is introduced to the surface of a wafer 206. In accordance with one embodiment, the surface of the wafer 206 may comprise a dual damascene structure 208 with a metal mask 210. The metal mask 210 may include, for example, TiN. A first type of residue 212 is strongly bonded to the metal mask 210. The first type of residue 212 may include, for example, TiF.

At 214, the metal mask 210 is etched and slightly undercut such that the first type of residue 212 is no longer bonded to the metal mask 210. At 216, the first solution 204 lifts and removes the first type of residue 212 from the metal mask 210.

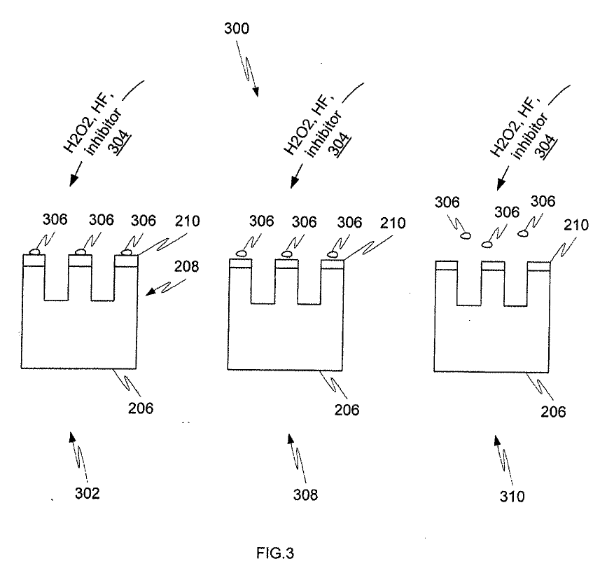

FIG. 3 is a schematic diagram 300 illustrating one embodiment of residue removal with a second solution 304 following the first step illustrated in FIG. 2. At 302, the second solution 304 is introduced to the surface of the wafer 206. In accordance with one embodiment, the second solution 304 may include a mixed solution of H2SO4 and HF. In accordance with another embodiment, the second solution 304 may include at least the following three components: H2SO4, HF, and an inhibitor. For illustration purposes, the inhibitor may comprise a BTA (Benzotriazole) or TTA (Tolyltriazole). The concentration of the inhibitor may range from 10 ppm to 10,000 ppm. Those of ordinary skills in the art will recognize that the inhibitor may include other components that provide similar results.

As previously described, the surface of the wafer 206 may comprise a dual damascene structure 208 with the metal mask 210. The metal mask 210 may include, for example, TiN. A second type of residue 306 includes metal fluorite compounds precipitated with time that is bonded to the metal mask 210. The second type of residue 306 may include, for example, TiFx.

At 308, the metal mask 210 is etched and slightly undercut such that the second type of residue 306 is no longer bonded to the metal mask 210. At 310, the second solution 304 dissolves by lifting and removing the second type of residue 306 from the metal mask 210.

FIG. 4 is a schematic diagram illustrating one embodiment of an apparatus for cleaning a dual damascene structure with metal hard mask of a wafer. An on-board buffer station 402 is coupled to a mixing chamber 404.

The on-board buffer station 402 may include a first buffer chamber 406, a second buffer chamber 408, and a de-ionized water valve 410. The first buffer chamber 406 includes the first solution previously described. The second buffer chamber 408 includes the second solution previously described. The valve 410 is connected to a source of de-ionized water (not shown) and is coupled to the mixing chamber 404.

The mixing chamber 404 may include a first mixing chamber 412, a second mixing chamber 414, a de-ionized water heater 416, a conduit 418, a first nozzle 420, and a second nozzle 422. The de-ionized water heater 416 is coupled to the de-ionized water valve 410. The first mixing chamber 412 is coupled to the first buffer chamber 406 of the on-board buffer station 402, the di-ionized water valve 410, and the de-ionized water 416. The second mixing chamber 414 is coupled to the second buffer chamber 408 of the on-board buffer station 402, the di-ionized water valve 410, and the de-ionized water 416. The conduit 418 receives a first mixture from the first mixing chamber 412 and a second mixture from the second mixing chamber 414. The conduit 418 is further coupled to the de-ionized water heater 416 and the de-ionized water valve 410. The first nozzle 420 and the second nozzle 422 are coupled to the conduit 418 for dispensing the first mixture and the second mixture onto a surface of a wafer 424.

In accordance with one embodiment, the process presently described is run in two chemical steps in one chamber. The first nozzle 420 may dispense H2O2 for TiN metal hard mask undercut. The wafer may then be rinsed with DIW. The second nozzle 422 may dispense the second mixture to dissolve fluorite on the wafer.

In accordance with one embodiment, the on-board buffer station 402 dilutes a concentrated (30%) H2O2. The first nozzle 420 delivers a diluted (6%) H2O2 on the surface of the wafer 424.

In accordance with one embodiment, the on-board buffer station 402 dilutes a concentrated second solution (for example, 66% of H2SO4 and 9000 ppm HF mixed solution). The second nozzle 422 delivers a diluted solution (5.9% H2SO4 and 800 ppm HF mixed solution) on the surface of the wafer 424.

In accordance with another embodiment, the chemical delivery system has two chemical vessels and two dispense arms for running two different cleaning chemicals.

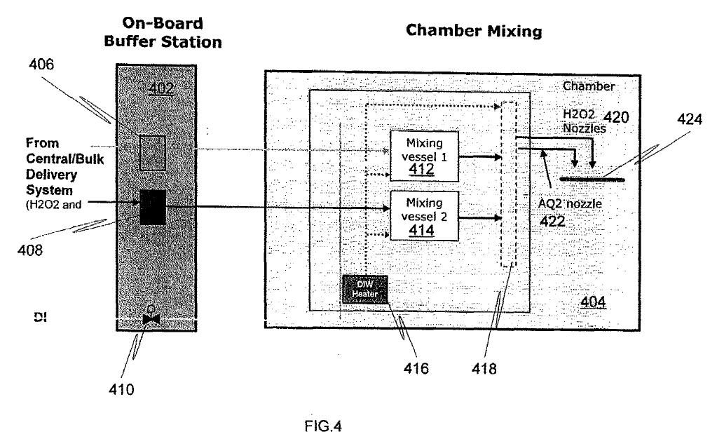

FIG. 5 is a photographic illustration showing residues on a wafer.

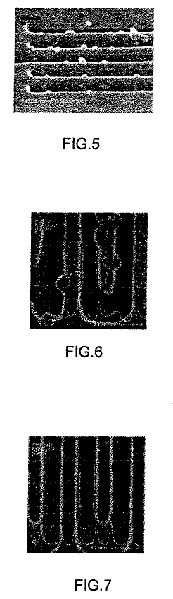

FIG. 6 is a photographic illustration showing a close up of residues on a wafer.

FIG. 7 is a photographic illustration showing a wafer structure free of residue after the cleaning method described herein.

Although the operations of the method(s) herein are shown and described in a particular order, the order of the operations of each method may be altered so that certain operations may be performed in an inverse order or so that certain operation may be performed, at least in part, concurrently with other operations. In another embodiment, instructions or sub-operations of distinct operations may be in an intermittent and/or alternating manner.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

1. A method for removing residue on a wafer comprising:
applying a first solution to the wafer, the first solution including H2O2; and
removing a residue bonded to a metal mask of the wafer with the first solution;
rinsing the wafer with de-ionized water after applying the first solution;
applying a second solution to the wafer, the second solution including H2SO4, HF, and an inhibitor; and
removing a metal fluoride compound residue from the metal mask of the wafer with the second solution.

2. The method of claim 1 wherein the wafer includes a wafer having a dual damascene structure with the metal mask.

3. The method of claim 2 wherein the metal mask includes TiN.

4. The method of claim 1 wherein the first type of residue includes a residue bonded to a metal mask of the wafer.

5. The method of claim 4 wherein the residue includes TiF.

6. The method of claim 1 wherein the second type of residue includes a metal fluorite compound precipitated with time.

7. The method of claim 6 wherein the metal fluorite compound includes TiF.

8. The method of claim 1 wherein the first solution includes a 6% diluted H2O2.

9. The method of claim 1 wherein the second solution includes a 5.9% diluted H2SO4, an 800ppm HF, and the inhibitor.

10. The method of claim 1 further comprising:
rinsing the wafer with de-ionized water between applying the first solution and applying the second solution.

11. An apparatus for removing residue on a wafer comprising:
a first mixing chamber coupled to a first nozzle to dispense a first solution on the wafer, the first solution for removing a first type of residue bonded to a metal mask on the wafer; and
a second mixing chamber coupled to a second nozzle to dispense a second solution on the wafer, the second solution for removing a second type of residue bonded to the metal mask on the wafer.

12. The apparatus of claim 11 wherein the wafer includes a wafer having a dual damascene structure with the metal mask.

13. The apparatus of claim 12 wherein the metal mask includes TiN.

14. The apparatus of claim 11 wherein the first type of residue includes TiF.

15. The apparatus of claim 11 wherein the second type of residue includes a metal fluorite compound precipitated with time.

16. The apparatus of claim 15 wherein the metal fluorite compound includes TiF.

17. The apparatus of claim 11 wherein the first solution includes H2O2.

18. The apparatus of claim 11 wherein the second solution includes H2SO4, HF, and an inhibitor.

19. The apparatus of claim 11 further comprising:
a third nozzle to dispense de-ionized water on the wafer.

20. The apparatus of claim 11 further comprising:
a mixing chamber comprising the first mixing chamber and the second mixing chamber; and
a buffer station coupled to the mixing chamber.
